(19) United States
(12) Patent Application Publication
(10) Pub. No.: US 2010/0303217 A1
(43) Pub. Date: Dec. 2, 2010

(54) MONITOR WITH NETWORK CONNECTION FUNCTION

(75) Inventor: HAI-LI WANG, Shenzhen City (CN)

Correspondence Address: Altis Law Group, Inc.;ATTN: Steven Reiss, 288 SOUTH MAYO AVENUE, CITY OF INDUSTRY, CA, 91789, US

(73) Assignees: HONG FU JIN PRECISION INDUSTRY (ShenZhen) CO., LTD., Shenzhen City (CN); HON HAI PRECISION INDUSTRY CO., LTD., Tu-Cheng (TW)

(21) Appl. No.: 12/479,866

(22) Filed: Jun. 8, 2009

(30) Foreign Application Priority Data
May 27, 2009 (CN) 200910302689.2

(51) Int. Cl. H04M 11/00

(52) U.S. Cl. 379/93.14; 379/413.02

(57) ABSTRACT

A monitor includes a video circuit, a modem circuit, and a router circuit. The video circuit controls display of the monitor. The modem circuit is connected to a phone line interface. The router circuit is connected to the modem circuit and a number of network interfaces. The modem circuit enables the phone line interface to communicate with the router circuit, and the router circuit outputs multi-channel network signals via the number of network interfaces.

### BACKGROUND

1. Technical Field

The present disclosure relates to a monitor.

2. Description of Related Art

Nowadays, computers are widely used for word processing, multimedia playing, and access to internet for both research and communications. Monitors are often put on desks as output devices of the computers. However, most monitors only function as a display.

### BRIEF DESCRIPTION OF THE DRAWINGS

FIG. 1 is a block diagram of an embodiment of a monitor.

FIG. 2 is a schematic back view of the monitor of FIG. 1, according to an embodiment.

### DETAILED DESCRIPTION

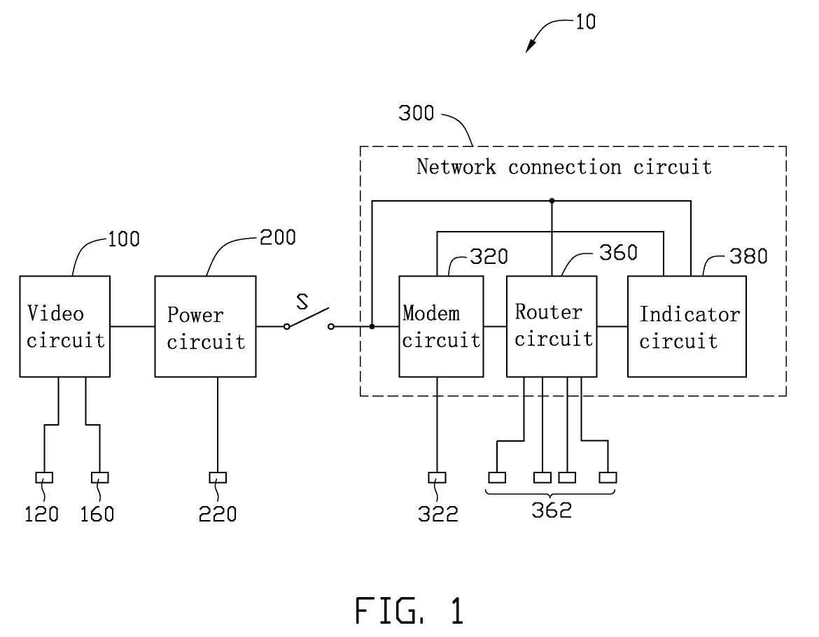

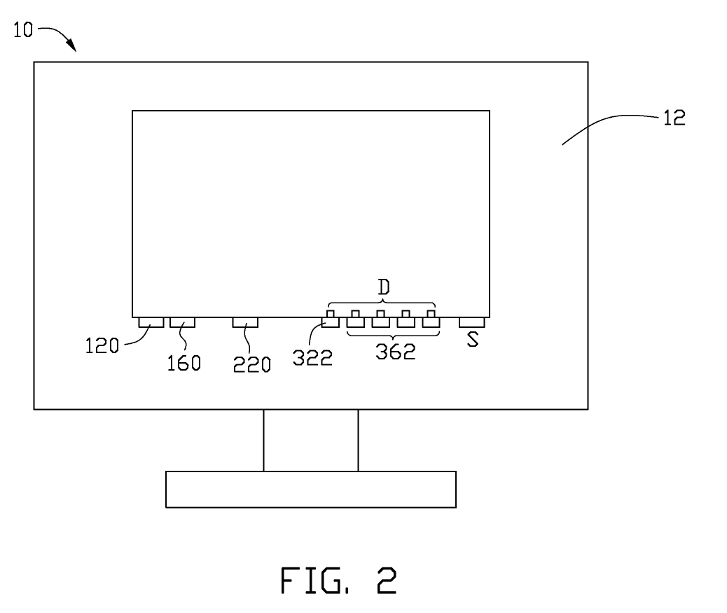

Referring to FIGS. 1 and 2, an exemplary embodiment of a monitor 10 includes a video circuit 100, a power circuit 200, a network connection circuit 300, a switch S, a video graphics array (VGA) interface 120, a digital visual interface (DVI) 160, a power interface 220, a phone line interface 322, and four network interfaces 362. In one embodiment, the video circuit 100, the power circuit 200, and the network connection circuit 300 are set on a printed circuit board (not shown) of the monitor 10. The switch S, the VGA interface 120, the DVI 160, the power interface 220, the phone line interface 322, and the network interfaces 362 are positioned on a back panel 12 of the monitor 10. In other embodiments, the number of the network interfaces 362 can be adjusted according to actual need.

The video circuit 100 is connected to the VGA interface 120 and the DVI 160, to control the monitor 10 to display graphics according to analog video signals received from the VGA interface 120 or digital video signals received from the DVI 160.

The power circuit 200 is connected to the power interface 220, to receive an external voltage signal, such as the 110V alternating current voltage signal, from the power interface 220, and to transform the external voltage signal to desired voltage signals, such as 5V or 12V direct current voltage signals, for the video circuit 100 and the network connection circuit 300. That is, the power circuit 200 supplies power to the video circuit 100 and the network connection circuit 300. The switch S is connected between the power circuit 200 and the network connection circuit 300, to turn on or turn off the network connection circuit 300.

The network connection circuit 300 includes a modem circuit 320, a router circuit 360, and an indicator circuit 380. The modem circuit 320 is connected between the phone line interface 322 and the router circuit 360, to transform analog signals received from the phone line interface 322 to digital signals and transmit the digital signals to the router circuit 360, and to transform digital signals received from the router circuit 360 to analog signals and transmit the analog signals to the phone line interface 322. That is, the modem circuit 320 enables the phone line interface 322 to communicate with the router circuit 360.

The router circuit 360 is connected to the network interfaces 362. Each network interface 362 is capable of connecting to a computer (not shown) via a cable, to enable the computer to connect to network via the router circuit 360. The router circuit 360 offers a unique network signal transmission channel to each computer connected to a corresponding network interface 362. That is, the router circuit 360 outputs multi-channel network signals for computers connected to the network interfaces 362, to enable the computers to connect to network.

The indicator circuit 380 is connected to the modem circuit 320 and the router circuit 360, and includes five light-emitting elements, such as five light-emitting diodes (LEDs) D. The LEDs D are operated to indicate connecting states and signal transmitting states of the phone line interface 322 and the network interfaces 362. For example, when a phone line is plugged into the phone line interface 322 normally, an LED D corresponding to the phone line interface 322 lights up, and when the phone line interface 322 is transmitting signals, the corresponding LED D flickers. In other embodiments, the number of the LEDs D can be adjusted according to the number of the network interfaces 362. The indicator circuit 380 is connected to the power circuit 200 via the switch S, to be turned on or turned off by the switch S.

When employing the network connection circuit 300, the monitor 10 enables computers connected to the network interfaces 362 to connect to network, without external modems and routers. Therefore, the monitor 10 not only has a display function but also has network connection function.

It is to be understood, however, that even though numerous characteristics and advantages of the present disclosure have been set forth in the foregoing description, together with details of the structure and function of the disclosure, the disclosure is illustrative only, and changes may be made in details, especially in matters of shape, size, and arrangement of parts within the principles of the disclosure to the full extent indicated by the broad general meaning of the terms in which the appended claims are expressed.

What is claimed is:

1. A monitor, comprising:
a video circuit to control display of the monitor;
a modem circuit connected to a phone line interface; and
a router circuit connected to the modem circuit and a plurality of network interfaces;
wherein the modem circuit enables the phone line interface to communicate with the router circuit, and the router circuit outputs multi-channel network signals via the plurality of network interfaces.

2. The monitor of claim 1, further comprising a power circuit and a switch, wherein the power circuit supplies power to the modem circuit and the router circuit via the switch, the switch is to turn on or turn off the modem circuit and the router circuit.

3. The monitor of claim 2, further comprising an indicator circuit connected to the modem circuit and the router circuit, wherein the indicator circuit comprises a plurality of light-emitting elements to indicate connecting states and signal transmitting states of the phone line interface and the plurality of network interfaces, and wherein the indicator circuit is connected to the power circuit via the switch, to be turned on or turned off by the switch.

4. The monitor of claim 3, wherein each light-emitting element is a light-emitting diode.

5. The monitor of claim 1, wherein the modem circuit transforms analog signals received from the phone line interface to digital signals and transmits the digital signal to the router circuit, and transforms digital signals received from the router circuit to analog signals and transmits the analog signals to the phone line interface, in response to the phone line interface communicating with the router circuit.

6. A monitor, comprising:
a video circuit to control display of the monitor; and
a network connection circuit to outputs multi-channel network signals, wherein the network connection circuit comprises:
a phone line interface;
a modem circuit connected to the phone line interface;
a plurality of network interfaces; and
a router circuit connected to the modem circuit and the plurality of network interfaces;
wherein the modem circuit enables the phone line interface to communicate with the router circuit, and the router circuit outputs multi-channel network signals via the plurality of network interfaces.

7. The monitor of claim 6, further comprising a power circuit and a switch, wherein the power circuit supplies power to the network connection circuit via the switch, the switch is to turn on or turn off the network connection circuit.

8. The monitor of claim 7, wherein the network connection circuit further comprises an indicator circuit connected to the modem circuit and the router circuit, the indicator circuit comprises a plurality of light-emitting elements to indicate connecting states and signal transmitting states of the phone line interface and the plurality of network interfaces.

9. The monitor of claim 8, wherein each light-emitting element is a light-emitting diode.

10. The monitor of claim 6, wherein the modem circuit transforms analog signals received from the phone line interface to digital signals transmitted to the router circuit, and transforms digital signals received from the router circuit to analog signals transmitted to the phone line interface, in response to the phone line interface communicating with the router circuit.
